(19) United States
(12) Patent Application Publication
(10) Pub. No.: US 2007/0291517 A1
(43) Pub. Date: Dec. 20, 2007

(54) Power supply circuit with positive feedback circuit

(75) Inventors: Hua Xiao, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/820,083

(22) Filed: Jun. 18, 2007

(30) Foreign Application Priority Data
Jun. 16, 2006 (TW) 95121706

(51) Int. Cl. H02J 3/00

(52) U.S. Cl. 363/34

(57) ABSTRACT

An power supply circuit (2) includes a bridge rectifier circuit (22); a control circuit (23) having a switch circuit (231) and a pulse width modulation circuit (232); a high frequency transformer (24); at least one commutating and filter circuit (25); and a positive feedback circuit (29). An alternating current voltage input from an external source is converted into a high frequency direct current voltage via the bridge rectifier circuit, and the high frequency DC voltage is outputted from the power supply circuit via the switch circuit, the high frequency transformer, and the at least one commutating and filter circuit. The positive feedback circuit receives the high frequency DC voltage outputted by the bridge rectifier circuit and transmits the high frequency DC voltage to the pulse width modulation circuit, and the pulse width modulation circuit controls a conduction time of the switch circuit according to the received high frequency DC voltage.

### FIELD OF THE INVENTION

The present invention relates to power supply circuits, and more particularly to a power supply circuit with a positive feedback circuit typically installed in a liquid crystal display (LCD) device.

### BACKGROUND

In general, a power supply circuit used in an LCD device has a Flyback structure. Thereby, the power supply circuit can receive a wide range of AC (alternating current) input voltages, so as to meet with the requirements of users in various countries all over the world. For example, the voltage receivable by the LCD device can be anywhere in the range from 90V (volts) to 240V. Due to the large span of the voltage receivable, the LCD device is liable to be disrupted by variations in the input voltage at any one particular power source. For example, if the voltage provided by a particular power outlet increases or decreases suddenly, this may adversely influence operation of the LCD device. That is, unstable input voltage signals may cause performance of the LCD device to be unstable.

FIG. 3 is a block diagram of a conventional power supply circuit installed in an LCD device. The power supply circuit 1 includes a bridge rectifier circuit 12, a control circuit 13, a high frequency transformer 14, a commutating and filter circuit 15, a negative feedback circuit 16, and a buffer circuit 18. The control circuit 13 includes a switch circuit 131 and a pulse width modulation circuit 132. An external input AC voltage is converted into a high frequency DC (direct current) voltage by the bridge rectifier circuit 12. The high frequency DC voltage transmits to a primary winding of the high frequency transformer 14 via the switch circuit 131. When the switch circuit 131 is turned off, the DC voltage applied to the primary winding of the high frequency transformer 14 is diverted to the buffer circuit 18. When the switch circuit 131 is turned on, the DC voltage applied to the primary winding of the high frequency transformer 14 couples to a secondary winding of the high frequency transformer 14. Thereby, the high frequency transformer 14 outputs a working voltage to the commutating and filter circuit 15. The commutating and filter circuit 15 modulates the working voltage to a predetermined working voltage. The negative feedback circuit 16 receives the working voltage, and transmits it to the pulse width modulation circuit 132. The pulse width modulation circuit 132 modulates the pulse width of the working voltage, to control the conduction (on-state) time of the switch circuit 131. This in turn ensures the commutating and filter circuit 15 outputs a stable working voltage to other parts of the LCD device.

The control circuit 13 provides protection against high-voltage and low-voltage. That is, the control circuit 13 can prevent the power supply circuit 1 from being influenced by unstable input voltages received from an external power source.

However, the input voltage provided by the external power source may increase suddenly without reaching an over-voltage threshold level of the power supply circuit 1. When this happens, the input power of the primary winding of the high frequency transformer 14 may increase significantly, and the voltage outputted by the secondary winding of the high frequency transformer 14 correspondingly increases significantly. Thus the commutating and filter circuit 15 may apply a large voltage load to the circuits in the other parts of the LCD device. That is, if an unstable input voltage does not reach the over-voltage threshold, the working voltage outputted by the power supply circuit 1 may still be unstable, and operation of the LCD device may be adversely affected.

Accordingly, what is needed is a power supply circuit that can overcome the above-described deficiencies.

### SUMMARY

An exemplary power supply circuit includes a bridge rectifier circuit; a control circuit having a switch circuit and a pulse width modulation circuit; a high frequency transformer; at least one commutating and filter circuit; and a positive feedback circuit. An alternating current (AC) voltage input from an external source is converted into a high frequency direct current (DC) voltage via the bridge rectifier circuit, and the high frequency DC voltage is outputted from the power supply circuit via the switch circuit, the high frequency transformer, and the at least one commutating and filter circuit. The positive feedback circuit receives the high frequency DC voltage outputted by the bridge rectifier circuit and transmits the high frequency DC voltage to the pulse width modulation circuit, and the pulse width modulation circuit controls a conduction time of the switch circuit according to the received high frequency DC voltage.

Other novel features and advantages will become apparent from the following detailed description of preferred embodiments when taken in conjunction with the accompanying drawings.

### BRIEF DESCRIPTION OF THE DRAWINGS

FIG. 1 is a block diagram of a power supply circuit according to an exemplary embodiment of the present invention.

FIG. 2 is a circuit diagram of the power supply circuit of FIG. 1.

FIG. 3 is a block diagram of a conventional power supply circuit.

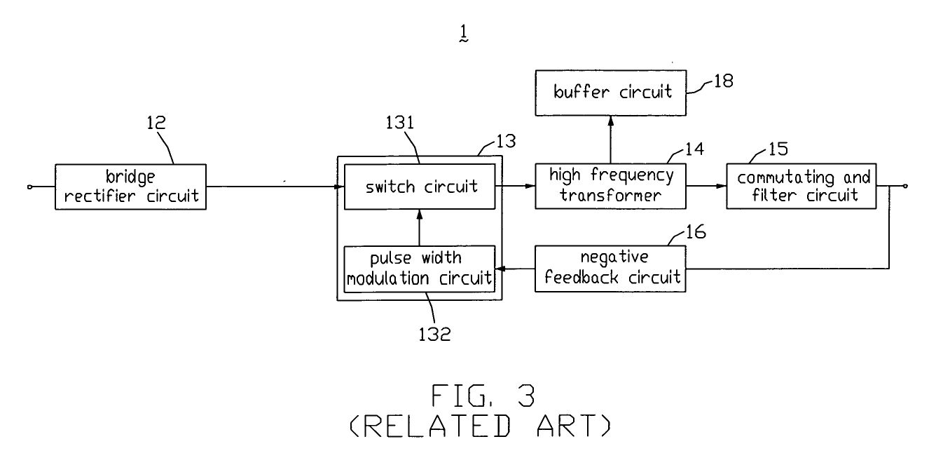

### DETAILED DESCRIPTION OF PREFERRED EMBODIMENTS

Reference will now be made to the drawings to describe preferred and exemplary embodiments in detail.

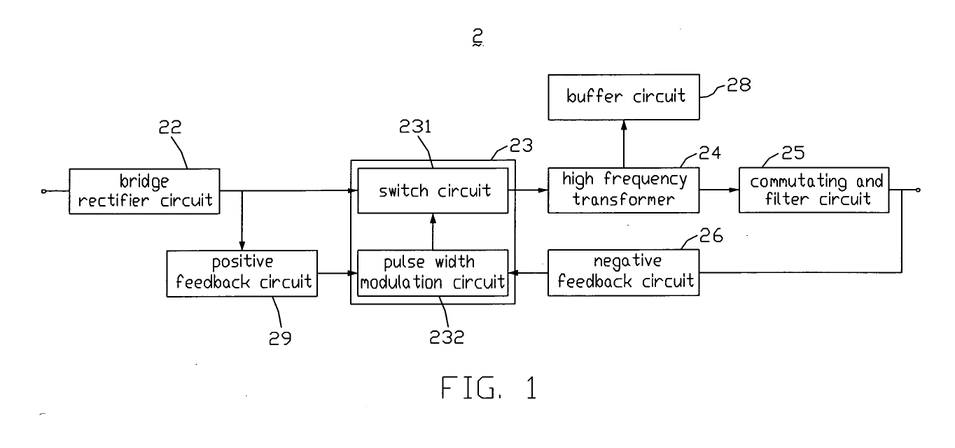

Referring to FIG. 1, this is a block diagram of a power supply circuit according to an exemplary embodiment of the present invention. The power supply circuit 2 includes a bridge rectifier circuit 22, a control circuit 23, a high frequency transformer 24, a commutating and filter circuit 25, a negative feedback circuit 26, a buffer circuit 28, and a positive feedback circuit 29. The control circuit 23 includes a switch circuit 231 and a pulse width modulation circuit 232.

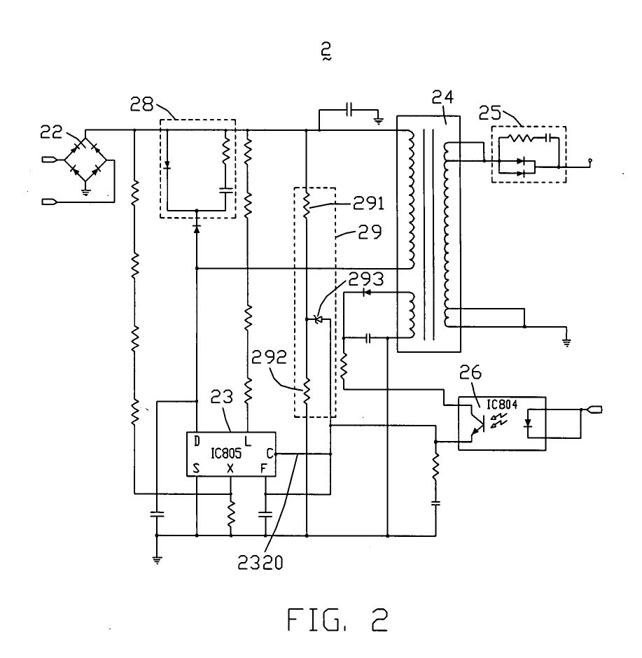

FIG. 2 is a circuit diagram of the power supply circuit 2. The control circuit 23 includes an integrated circuit (typically an “IC805”), and the negative feedback circuit 26 includes an optical coupling feedback member (typically an “IC804”). The IC805 has a function of providing high-voltage and low-voltage protection. The positive feedback circuit 29 includes a first resistance 291, a second resistance 292, and a Zener diode 293. The first and second resistances 291, 292 are connected in series between the bridge rectifier circuit 22 and ground. A node between the first and second resistances 291, 292 is connected to a cathode of the Zener diode 293. An anode of the Zener diode 293 is connected to a pulse width modulation port 2320 of the IC805.

An external input AC voltage is converted into a high frequency DC (direct current) voltage via the bridge rectifier circuit 22. The high frequency DC voltage transmits to a primary winding of the high frequency transformer 24 via the switch circuit 231 of the control circuit 23. When the switch circuit 231 is turned off, the DC voltage applied to the primary winding of the high frequency transformer 24 is diverted to the buffer circuit 28. When the switch circuit 231 is turned on, the DC voltage applied to the primary winding of the high frequency transformer 24 couples to a secondary winding of the high frequency transformer 24. Thereby, the high frequency transformer 24 outputs a working voltage to the commutating and filter circuit 25. The commutating and filter circuit 25 modulates the working voltage to a predetermined working voltage. The negative feedback circuit 26 receives the working voltage, and transmits it to the pulse width modulation circuit 232. The pulse width modulation circuit 232 modulates the pulse width of the working voltage, to control the conduction (on-state) time of the switch circuit 231. This in turn ensures the high frequency DC voltage transmitted to the high frequency transformer 24 is stable. Thus the commutating and filter circuit 15 outputs a stable working voltage to other parts of an associated electrical device such as an LCD device.

Operation of the position feedback circuit 29 is as follows. The first and second resistances 291, 291 cooperatively form a voltage dividing circuit. The high frequency DC voltage provided by the bridge rectifier circuit 22 is transmitted to the voltage dividing circuit. A voltage of the second resistance 292 is sampled to the Zener diode 293, and transmitted to the pulse width modulation port 2320 of the IC805. When the input voltage increases, the voltage of the second resistance 292 also increases, and a voltage of the Zener diode 293 is constant. Accordingly, the feedback voltage of the pulse width modulation port 2320 increases synchronously. At this time, the IC805 modulates the pulse width of the feedback voltage, to decrease a current outputted from a drain electrode of the IC805. Thereby, the high frequency DC voltage inputted to the high frequency transformer 24 is also decreased. Thus, the DC voltage inputted to the high frequency transformer 24 is maintained at a stable level.

Compared with the earlier-described conventional power supply circuit 1, the power supply circuit 2 includes a positive feedback circuit 29. The positive feedback circuit 29 can feed back and modulate a varying DC voltage outputted by the bridge rectifier circuit 22, so as to maintain the voltage inputted to the high frequency transformer 24 at a stable level. That is, application of a large voltage load to circuits in the other parts of the associated electrical device is avoided. This ensures the power supply circuit 2 can output a stable working voltage, and the associated electrical device can operate normally.

Various modifications and alterations are possible within the ambit of the invention herein. For example, the high frequency transformer 24 may have two, three, or more secondary windings. There can be two, three, or more commutating and filter circuits 25. The plural commutating and filter circuits 25 may be connected to the corresponding secondary windings, respectively.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A power supply circuit, comprising:
a bridge rectifier circuit;
a control circuit comprising a switch circuit and a pulse width modulation circuit;
a high frequency transformer;
at least one commutating and filter circuit; and
a positive feedback circuit;
wherein an alternating current (AC) voltage input from an external source is converted into a high frequency direct current (DC) voltage via the bridge rectifier circuit, the high frequency DC voltage is outputted from the power supply circuit via the switch circuit, the high frequency transformer, and the at least one commutating and filter circuit, the positive feedback circuit receives the high frequency DC voltage outputted by the bridge rectifier circuit and transmits the high frequency DC voltage to the pulse width modulation circuit, and the pulse width modulation circuit controls a conduction time of the switch circuit according to the received high frequency DC voltage.

2. The power supply circuit as claimed in claim 1, wherein the control circuit includes an integrated circuit with a pulse width modulation port.

3. The power supply circuit as claimed in claim 2, wherein the integrated circuit is an IC805 type integrated circuit.

4. The power supply circuit as claimed in claim 2, wherein the positive feedback circuit includes a first resistance, a second resistance, and a Zener diode, the first and second resistances are connected in series between the bridge rectifier circuit and ground, a node between the first and second resistances is connected to a cathode of the Zener diode, and an anode of the Zener diode is connected to the pulse width modulation port.

5. The power supply circuit as claimed in claim 1, further comprising a negative feedback circuit, wherein the negative feedback circuit receives a DC voltage outputted by the at least one commutating and filter circuit, and transmits the DC voltage to the pulse width modulation circuit.

6. The power supply circuit as claimed in claim 5, wherein the negative feedback circuit comprises an optical coupling feedback integrated circuit IC804.

7. The power supply circuit as claimed in claim 6, wherein the optical coupling feedback integrated circuit is an IC804 type integrated circuit.

8. The power supply circuit as claimed in claim 1, further comprising a buffer circuit, wherein the buffer circuit diverts the DC voltage outputted to the high frequency transformer when the switch circuit is turned off.

9. A power supply circuit assembly comprising:
a bridge rectifier circuit; and
a control circuit comprising a switch circuit and a pulse width modulation circuit; wherein
a positive feedback circuit and a negative feedback circuit respectively connected to the pulse width modulation circuit which controls a conduction time of the switch circuit.
